(19) United States
(12) Patent Application Publication
(10) Pub. No.: US 2018/0340102 A1
(43) Pub. Date: Nov. 29, 2018

(54) USE OF NICKEL AND NICKEL-CONTAINING ALLOYS AS CONDUCTIVE FILLERS IN ADHESIVE FORMULATIONS

(71) Applicant: Henkel IP & Holding GmbH, Duesseldorf (DE)

(72) Inventors: Stephen A. Ruatta, South Pasadena, CA (US); George Carson, Lake Forest, CA (US); Li Yao, Irvine, CA (US)

(21) Appl. No.: 15/953,674

(22) Filed: Apr. 16, 2018

Related U.S. Application Data
(63) Continuation of application No. PCT/US2016/057033, filed on Oct. 14, 2016.
(60) Provisional application No. 62/241,830, filed on Oct. 15, 2015.

(51) Int. Cl. C09J 9/02; C09J 11/04; C09J 133/10; C09J 163/04; C09J 179/04; C09D 11/52; C08K 9/04

(52) U.S. Cl. CPC C09J 9/02; C09J 11/04; C09J 133/10; C08K 3/08; C09J 179/04; C09D 11/52; C08K 9/04; C09J 163/04

(57) ABSTRACT

In accordance with the present invention, there are provided novel conductive adhesives and methods for the preparation thereof. In another aspect, the present invention provides novel conductive inks and methods for the preparation thereof. In yet another aspect, the present invention provides novel die attach films and methods for the preparation thereof. In still another aspect, the present invention provides novel die attach pastes and methods for the preparation thereof.

### FIELD OF THE INVENTION

The present invention relates to conductive adhesives and methods for the preparation thereof. In another aspect, the invention relates to conductive inks and methods for the preparation thereof. In yet another aspect, the invention relates to die attach films and methods for the preparation thereof. In still another aspect, the invention relates to die attach pastes and methods for the preparation thereof. In a further aspect, the invention relates to assemblies comprising a first and a second article adhered to one another with a conductive adhesive according to the present invention, and methods for the preparation thereof.

### BACKGROUND OF THE INVENTION

While silver and copper are widely used in conductive adhesives, there are potential problems with their use. For example, while silver is a good conductor, it is expensive. Similarly, while copper is also a good conductor, it corrodes easily. In addition, both silver and copper are expensive.

Accordingly, there is a need in the art for conductive materials which provide conductivity levels of the same magnitude as provided by silver, while at the same time being relatively non-corrosive, stable to oxidation, and highly cost competitive with silver-based conductive formulations.

### SUMMARY OF THE INVENTION

In accordance with the present invention, there are provided novel conductive adhesives and methods for the preparation thereof. In another aspect, the present invention provides novel conductive inks and methods for the preparation thereof. In yet another aspect, the present invention provides novel die attach films and methods for the preparation thereof. In still another aspect, the present invention provides novel die attach pastes and methods for the preparation thereof. In a further aspect, the present invention provides assemblies comprising a first and a second article adhered to one another with a conductive adhesive according to the present invention, and methods for the preparation thereof.

### DETAILED DESCRIPTION OF THE INVENTION

In accordance with the present invention, there are provided electrically conductive adhesive formulations, said formulations comprising:
about 5 up to about 50 wt % of an organic matrix,
about 45 up to about 95 wt % of a particulated filler, wherein:
   about 5 up to about 100 wt % of said particulated filler is particulated nickel or a particulated nickel-alloy, and
   0 up to about 95 wt % of said particulated filler is particulated, conductive non-nickel-containing filler,
optionally a curing agent, which, when present, is present in the range of about 0.1 up to about 20 wt %, and
optionally a reactive and/or non-reactive organic diluent therefor,
wherein said formulation, upon curing thereof, has a volume resistivity in the range of about 10⁻⁵ up to about 10 Ohm cm.

Formulations according to the invention can be further characterized by one or more of the following:
the volume resistivity of said formulation falls in the range of about 10⁻⁴ up to about 10 Ohm cm; in some embodiments, the volume resistivity of said formulation falls in the range of about 10⁻³ up to about 10 Ohm cm; in some embodiments, the volume resistivity of said formulation falls in the range of about 10⁻² up to about 10 Ohm cm;
said formulation is such that the effect of corrosion on the electrical properties of the particulated filler is minimal, and
the coefficient of thermal expansion (CTE) of said formulation is highly compatible with silicon wafers to which it may be applied.

In accordance with another aspect of the present invention, there are provided assemblies comprising a first article permanently adhered to a second article by a cured aliquot of the adhesive formulation described herein.

### Organic Matrices

Organic matrices contemplated for use herein include at least one thermosetting resin or thermoplastic resin component, not including any organic solvent that may be employed. The thermosetting resin or thermoplastic resin component(s) are provided in the compositions described herein to improve one or more performance properties such as, for example, film quality, tackiness, wetting ability, flexibility, work life, high temperature adhesion, resin-filler compatibility, and/or curability of adhesive layers (e.g., films) prepared from the compositions. In addition, the thermosetting resin or thermoplastic resin component(s) are provided in the compositions described herein to improve one or more performance properties such as, for example, rheology, dispensability, work life, and curability of adhesive layers (e.g., pastes) prepared from invention compositions.

The thermosetting resin or thermoplastic resin component(s) can be any resin capable of imparting one or more of the above-listed properties to the compositions, including, but not limited to an acetal, an acrylic monomer, oligomer, or polymer, an acrylonitrile-butadiene-styrene (ABS) polymer or copolymer or a polycarbonate/ABS alloy, an alkyd, a butadiene, a styrene-butadiene, a cellulosic, a coumarone-indene, a cyanate ester, a diallyl phthalate (DAP), an epoxy monomer, oligomer, or polymer, a flexible epoxy or polymer with epoxy functional groups, a fluoropolymer, a melamine-formaldehyde, a neoprene, a nitrile resin, a novolac, a nylon, a petroleum resin, a phenolic, a polyamide-imide, a polyarylate and polyarylate ether sulfone or ketone, a polybutylene, a polycarbonate, a polyester and co-polyestercarbonate, a polyetherester, a polyethylene, a polyimide, a maleimide, a nadimide, an itaconamide, a polyketone, a polyolefin, a polyphenylene oxide, a sulfide, an ether, a polypropylene and polypropylene-EPDM blend, a polystyrene, a polyurea, a polyurethane, a vinyl polymer, rubbers, a silicone polymer, a siloxane polymer, a styrene acrylonitrile, a styrene butadiene latex and other styrene copolymers, a sulfone polymer, a thermoplastic polyester (Saturated), a phthalate, an unsaturated polyester, a urea-formaldehyde, a polyacrylamide, a polyglycol, a polyacrylic acid, a poly(ethylene glycol), an inherently conductive polymer, a fluoropolymer, and the like, as well as combinations of any two or more thereof.

Maleimides, nadimides, or itaconamides contemplated for use herein have the structure:

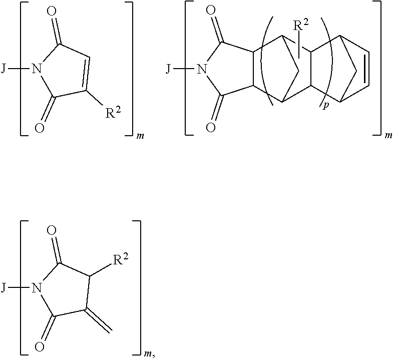

respectively, wherein:
m is 1-15,
p is 0-15,
each R² is independently selected from hydrogen or lower alkyl (such as C₁₋₅), and
J is a monovalent or a polyvalent radical comprising organic or organosiloxane radicals, and
combinations of any two or more thereof.

In certain embodiments, J is a monovalent or polyvalent radical selected from:
hydrocarbyl or substituted hydrocarbyl species typically having in the range of about 6 up to about 500 carbon atoms, where the hydrocarbyl species is selected from alkyl, alkenyl, alkynyl, cycloalkyl, cycloalkenyl, aryl, alkylaryl, arylalkyl, aryalkenyl, alkenylaryl, arylalkynyl or alkynylaryl, provided, however, that X can be aryl only when X comprises a combination of two or more different species;
hydrocarbylene or substituted hydrocarbylene species typically having in the range of about 6 up to about 500 carbon atoms, where the hydrocarbylene species are selected from alkylene, alkenylene, alkynylene, cycloalkylene, cycloalkenylene, arylene, alkylarylene, arylalkylene, arylalkenylene, alkenylarylene, arylalkynylene or alkynylarylene,
heterocyclic or substituted heterocyclic species typically having in the range of about 6 up to about 500 carbon atoms,
polysiloxane, or
polysiloxane-polyurethane block copolymers, as well as
   combinations of one or more of the above with a linker selected from covalent bond, —O—, —S—, —NR—, —NR—C(O)—, —NR—C(O)—O—, —NR—C(O)—NR—, —S—C(O)—, —S—C(O)—O—, —S—C(O)—NR—, —O—S(O)₂—, —O—S(O)₂—O—, —O—S(O)₂—NR—, —O—S(O)—, —O—S(O)—O—, —O—S(O)—NR—, —O—NR—C(O)—, —O—NR—C(O)—O—, —O—NR—C(O)—NR—, —NR—O—C(O)—, —NR—O—C(O)—O—, —NR—O—C(O)—NR—, —O—NR—C(S)—, —O—NR—C(S)—O—, —O—NR—C(S)—NR—, —NR—O—C(S)—, —NR—O—C(S)—O—, —NR—O—C(S)—NR—, —O—C(S)—, —O—C(S)—O—, —O—C(S)—NR—, —NR—C(S)—, —NR—C(S)—O—, —NR—C(S)—NR—, —S—S(O)₂—, —S—S(O)₂—O—, —S—S(O)₂—NR—, —NR—O—S(O)—, —NR—O—S(O)—O—, —NR—O—S(O)—NR—, —NR—O—S(O)₂—, —NR—O—S(O)₂—O—, —NR—O—S(O)₂—NR—, —O—NR—S(O)—, —O—NR—S(O)—O—, —O—NR—S(O)—NR—, —O—NR—S(O)₂—O—, —O—NR—S(O)₂—NR—, —O—NR—S(O)₂—, —O—P(O)R₂—, —S—P(O)R₂—, or —NR—P(O)R₂—; where each R is independently hydrogen, alkyl or substituted alkyl.

Exemplary maleimides, nadimides, or itaconamides contemplated for use herein include 4,4′-diphenylmethane bismaleimide, 4,4′-diiphenylether bismaleimide, 4,4′diiphenylsulfone bismaleimide, phenylmethane maleimide, m-phenylene bismaleimide, 2,2′-bis[4-(4-maleimidophenoxy)phenyl]propane, 3,3′-dimethyl-5,5′-diethyl-4,4′-diphenylmethane bismaleimide, 4-methyl-1,3-phenylene bismaleimide, 1,6′-bismaleimide-(2,2,4-trimethyl)hexane, 1,3-bis(3-maleimidophenoxy)benzene, 1,3-bis(4-maleimidophenoxy)-benzene, and the like.

The one or more epoxy monomers, oligomers, or polymers contemplated for use herein, which are also referred to herein as epoxy resins, can include an epoxy having an aliphatic backbone, an aromatic backbone, a modified epoxy resin, or a mixture of these. In certain embodiments, the one or more epoxy monomers, oligomers, or polymers include a functionalized epoxy monomer, oligomer, or polymer. The epoxy functionality in the epoxy resin is at least one. In some embodiments, the epoxy resin is one (i.e., the epoxy resin is a mono-functional epoxy resin). In other embodiments, the epoxy resin contains at least two or more epoxy functional groups (e.g., 2, 3, 4, 5, or more).

The epoxy resins contemplated for use in the practice of the present invention are not limited to resins having a particular molecular weight. Exemplary epoxy resins can have a molecular weight in the range of about 50 or less up to about 1,000,000. In certain embodiments, epoxy resins contemplated for use herein have a molecular weight in the range of about 200,000 up to about 900,000. In other embodiments, epoxy resins contemplated for use herein have a molecular weight in the range of about 10,000 up to about 200,000. In still other embodiments, epoxy resins contemplated for use herein have a molecular weight in the range of about 1,000 up to about 10,000. In still other embodiments, epoxy resins contemplated for use herein have a molecular weight in the range of about 50 up to about 10,000.

In some embodiments, the epoxy resins can be liquid epoxy resins or solid epoxy resins containing aromatic and/or aliphatic backbones, such as the diglycidyl ether of bisphenol F or the diglycidyl ether of bisphenol A. Optionally, the epoxy resin is a flexible epoxy. The flexible epoxy can have a chain length of variable length (e.g., a short chain or a long chain), such as a short-chain length or long-chain length polyglycol diepoxide liquid resin. An exemplary short chain length polyglycol diepoxide liquid resin includes D.E.R. 736 and an exemplary long chain length polyglycol diepoxide liquid resin includes D.E.R. 732, both commercially available from Dow Chemical Company (Midland, Mich.).

Exemplary epoxies contemplated for use herein include liquid-type epoxy resins based on bisphenol A, solid-type epoxy resins based on bisphenol A, liquid-type epoxy resins based on bisphenol F (e.g., Epiclon EXA-835LV), multifunctional epoxy resins based on phenol-novolac resin, dicyclopentadiene-type epoxy resins (e.g., Epiclon HP-7200L), naphthalene-type epoxy resins, and the like, as well as mixtures of any two or more thereof.

In certain embodiments, epoxies contemplated for use herein include diglycidyl ether of bisphenol A epoxy resin, of diglycidyl ether of bisphenol F epoxy resin, epoxy novolac resins, epoxy cresol resins, and the like.

In some embodiments, the epoxy resins can be toughened epoxy resins, such as epoxidized carboxyl-terminated butadiene-acrylonitrile (CTBN) oligomers or polymers, epoxidized polybutadiene diglycidylether oligomers or polymers, heterocyclic epoxy resins (e.g., isocyanate-modified epoxy resins), and the like.

In certain embodiments, the epoxidized CTBN oligomer or polymer is an epoxy-containing derivative of an oligomeric or polymeric precursor having the structure:

HOOC[(Bu)ₓ(ACN)_{y}]ₘCOOH

wherein:

each Bu is a butylene moiety (e.g., 1,2-butadienyl or 1,4-butadienyl),

each ACN is an acrylonitrile moiety,

the Bu units and the ACN units can be arranged randomly or in blocks,

each of x and y are greater than zero, provided the total of x+y=1,

the ratio of x:y falls in the range of about 10:1-1:10, and

m falls in the range of about 20 about 100.

As readily recognized by those of skill in the art, epoxidized CTBN oligomers or polymers can be made in a variety of ways, e.g., from (1) a carboxyl terminated butadiene/acrylonitrile copolymer, (2) an epoxy resin and (3) bisphenol A:

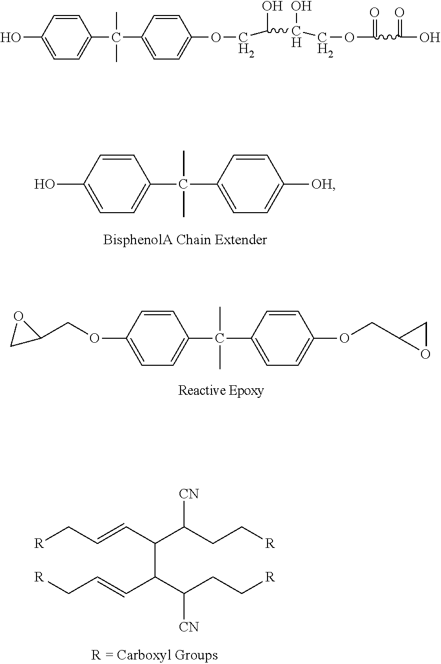

by reaction between the carboxylic acid group of CTBN and epoxies (via chain-extension reactions), and the like.

In some embodiments, the epoxy resin can include epoxidized CTBN oligomers or polymers made from (1) a carboxyl terminated butadiene/acrylonitrile copolymer, (2) an epoxy resin, and (3) bisphenol A as described above; Hypro™ Epoxy-Functional Butadiene-Acrylonitrile Polymers (formerly Hycar® ETBN), and the like.

In certain embodiments, the epoxy resin contemplated for use herein includes a rubber or elastomer-modified epoxy. Rubber or elastomer-modified epoxies include epoxidized derivatives of:

(a) homopolymers or copolymers of conjugated dienes having a weight average molecular weight (M_{w}) of 30,000 to 400,000 or higher as described in U.S. Pat. No. 4,020,036 (the entire contents of which are hereby incorporated by reference herein), in which conjugated dienes contain from 4-11 carbon atoms per molecule (such as 1,3-butadiene, isoprene, and the like);

(b) epihalohydrin homopolymers, a copolymer of two or more epihalohydrin monomers, or a copolymer of an epihalohydrin monomer(s) with an oxide monomer(s) having a number average molecular weight (Mₙ) which varies from about 800 to about 50,000, as described in U.S. Pat. No. 4,101,604 (the entire contents of which are hereby incorporated by reference herein);
(c) hydrocarbon polymers including ethylene/propylene copolymers and copolymers of ethylene/propylene and at least one nonconjugated diene, such as ethylene/propylene/hexadiene/norbornadiene, as described in U.S. Pat. No. 4,161,471; or

(d) conjugated diene butyl elastomers, such as copolymers consisting of from 85 to 99.5% by weight of a C₄-C₅ olefin combined with about 0.5 to about 15% by weight of a conjugated multi-olefin having 4 to 14 carbon atoms, copolymers of isobutylene and isoprene where a major portion of the isoprene units combined therein have conjugated diene unsaturation (see, for example, U.S. Pat. No. 4,160,759; the entire contents of which are hereby incorporated by reference herein).

In certain embodiments, the epoxy resin is an epoxidized polybutadiene diglycidylether oligomer or polymer.

In certain embodiments, epoxidized polybutadiene diglycidylether oligomers contemplated for use herein have the structure:

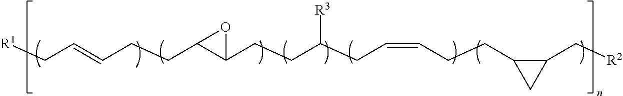

wherein:

R¹ and R² are each independently H or lower alkyl,

R³ is H, saturated or unsaturated hydrocarbyl, or epoxy,

at least 1 epoxy-containing repeating unit set forth above, and at least one olefinic repeating unit set forth above are present in each oligomer, and, when present, in the range of 1-10 of each repeating unit is present, and

n falls in the range of 2-150.

In certain embodiments, an epoxidized polybutadiene diglycidylether oligomer or polymer contemplated for use in the practice of the present invention has the structure:

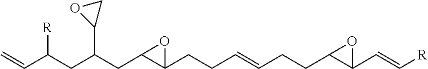

wherein R is H, OH, lower alkyl, epoxy, oxirane-substituted lower alkyl, aryl, alkaryl, and the like. Further examples of the epoxy resin contemplated for use herein include epoxies having a flexible backbone. For example, the epoxy resin can include:

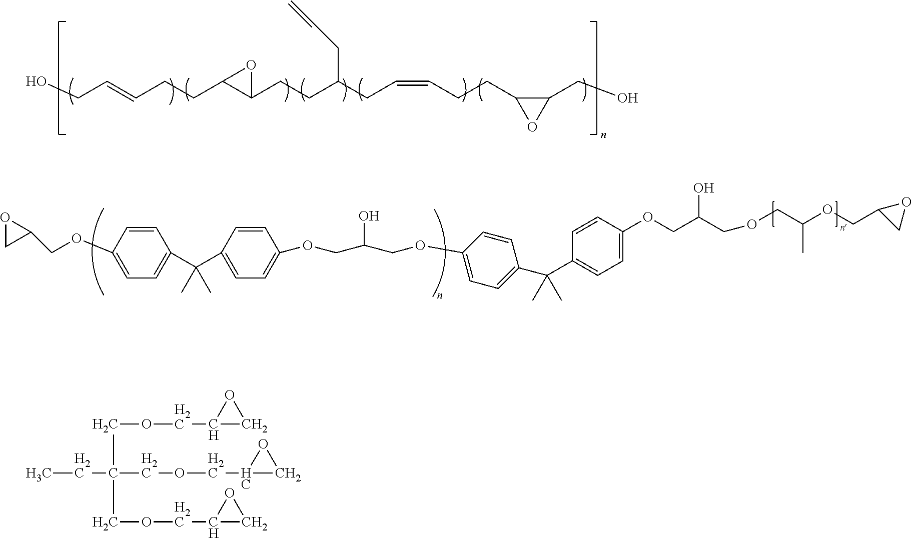

and the like.

In some embodiments, additional epoxy materials may be included in invention formulations. When included in invention formulations, a wide variety of epoxy-functionalized resins are contemplated for use herein, e.g., epoxy resins based on bisphenol A (e.g., Epon Resin 834), epoxy resins based on bisphenol F (e.g., RSL-1739 or JER YL980), multifunctional epoxy resins based on phenol-novolac resin, dicyclopentadiene-type epoxy resins (e.g., Epiclon HP-7200L), naphthalene-type epoxy resins, and the like, as well as mixtures of any two or more thereof.

Exemplary epoxy-functionalized resins contemplated for use herein include the diepoxide of the cycloaliphatic alcohol, hydrogenated bisphenol A (commercially available as Epalloy 5000), a difunctional cycloaliphatic glycidyl ester of hexahydrophthallic anhydride (commercially available as Epalloy 5200), Epiclon EXA-835LV, Epiclon HP-7200L, and the like, as well as mixtures of any two or more thereof.

Additional examples of conventional epoxy materials which are suitable for use as optional additional component of invention formulations include:

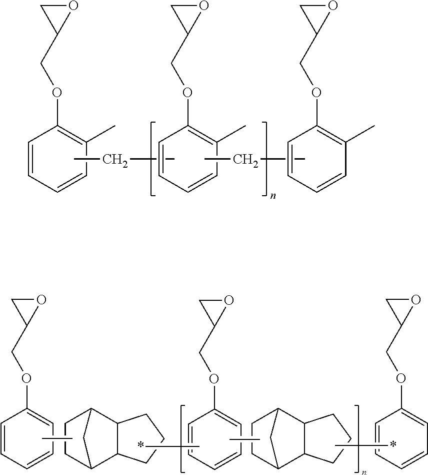

and the like.

Exemplary epoxy-functionalized resins contemplated for use herein include the epoxidized CTBN rubbers 561A, 24-440B, and EP-7 (commercially available from Henkel Corporation; Salisbury, N.C. & Rancho Dominguez, Calif.); diepoxide of the cycloaliphatic alcohol hydrogenated bisphenol A (commercially available as Epalloy 5000); a difunctional cycloaliphatic glycidyl ester of hexahydrophthallic anhydride (commercially available as Epalloy 5200); ERL 4299; CY-179; CY-184; and the like, as well as mixtures of any two or more thereof.

Optionally, the epoxy resin can be a copolymer that has a backbone that is a mixture of monomeric units (i.e., a hybrid backbone). The epoxy resin can include straight or branched chain segments. In certain embodiments, the epoxy resin can be an epoxidized silicone monomer or oligomer. Optionally, the epoxy resin can be a flexible epoxy-silicone copolymer. Exemplary flexible epoxy-silicone copolymers contemplated for use herein include ALBIFLEX 296 and ALBIFLEX 348, both commercially available from Evonik Industries (Germany).

In some embodiments, one epoxy monomer, oligomer, or polymer is present in the composition. In certain embodiments, combinations of epoxy monomers, oligomers, or polymers are present in the composition. For example, two or more, three or more, four or more, five or more, or six or more epoxy monomers, oligomers, or polymers are present in the composition. Combinations of epoxy resins can be selected and used to achieve the desired properties for films or pastes prepared from the compositions. For example, combinations of epoxy resins can be selected such that films prepared from the compositions exhibit one or more of the following improved properties: film quality, tackiness, wetting ability, flexibility, work life, high temperature adhesion, resin-filler compatibility, sintering capability, and the like. Combinations of epoxy resins can be selected such that pastes prepared from the compositions exhibit one or more improved properties such as rheology, dispensability, work life, sintering capability, and the like.

The one or more epoxy monomers, oligomers, or polymers can be present in the composition in an amount of up to about 50 percent by weight of the total solids content of the composition (i.e., the composition excluding diluents). For example, the one or more epoxy monomers, oligomers, or polymers can be present in the composition in an amount of from about 5 percent by weight to about 50 percent by weight, from about 10 percent by weight to about 50 percent by weight, or from about 10 percent by weight to about 35 percent by weight. In some embodiments, the one or more epoxy monomers, oligomers, or polymers can be present in the composition in an amount of about 50 percent by weight or less, about 45 percent by weight or less, about 40 percent by weight or less, about 35 percent by weight or less, about 30 percent by weight or less, about 25 percent by weight or less, about 20 percent by weight or less, about 15 percent by weight or less, about 10 percent by weight or less, or about 5 percent by weight or less based on the weight of the total solids content of the composition.

The compositions described herein can further include an acrylic monomer, polymer, or oligomer. Acrylates contemplated for use in the practice of the present invention are well known in the art. See, for example, U.S. Pat. No. 5,717,034, the entire contents of which are hereby incorporated by reference herein.

The acrylic monomers, polymers, or oligomers contemplated for use in the practice of the present invention are not limited to a particular molecular weight. Exemplary acrylic resins can have a molecular weight in the range of about 50 or less up to about 1,000,000. In some embodiments, acrylic polymers contemplated for use herein can have a molecular weight in the range of about 100 up to about 10,000 and a Tg in the range of about −40° C. up to about 20° C. In certain embodiments, acrylic polymers contemplated for use herein have a molecular weight in the range of about 10,000 up to about 900,000 (e.g., about 100,000 up to about 900,000 or about 200,000 up to about 900,000) and a Tg in the range of about −40° C. up to about 20° C. Examples of acrylic copolymers for use in the compositions described herein include Teisan Resin SG-P3 and Teisan Resin SG-80H (both commercially available from Nagase Chemtex Corp.; Japan). Optionally, the acrylic polymer or oligomer for use in the compositions described herein can be degradable acrylic polymers or oligomers or epoxy-modified acrylic resins.

The acrylic monomers, polymers, and/or oligomers can be present in the composition in an amount of up to about 50 percent by weight of the total solids content of the composition. For example, the acrylic monomers, copolymers, and/or oligomers can be present in the composition in an amount from about 5 percent by weight to about 50 percent by weight, or from about 10 percent by weight to about 50 percent by weight, or from about 10 percent by weight to about 35 percent by weight, or from about 5 percent by weight to about 30 percent by weight, or from about 5 percent by weight to about 20 percent by weight. In some embodiments, the acrylic monomers, copolymers, and/or oligomers are present in the composition in an amount of about 50 percent by weight or less, about 45 percent by weight or less, about 40 percent by weight or less, about 35 percent by weight or less, about 30 percent by weight or less, about 25 percent by weight or less, 20 percent by weight or less, about 15 percent by weight or less, about 10 percent by weight or less, or about 5 percent by weight or less based on the weight of the total solids content of the composition.

Exemplary (meth)acrylates contemplated for use herein include monofunctional (meth)acrylates, difunctional (meth)acrylates, trifunctional (meth)acrylates, polyfunctional (meth)acrylates, and the like, as well as mixtures of any two or more thereof.

Additional thermosetting resin or thermoplastic resin components contemplated for use in the compositions described herein can include polyurethanes, cyanate esters, polyvinyl alcohols, polyesters, polyureas, polyvinyl acetal resins, and phenoxy resins. In some embodiments, the compositions can include imide-containing monomers, oligomers, or polymers, such as maleimides, nadimides, itaconimides, bismaleimides, or polyimides.

The thermosetting resin or thermoplastic resin components, including the one or more epoxy monomers, polymers, or oligomers; the acrylic monomers, polymers, or oligomers, the phenolics; the novalacs; the polyurethanes; the cyanate esters; the polyvinyl alcohols; the polyesters; the polyureas; the polyvinyl acetal resins; the phenoxy resins; and/or the imide-containing monomers, polymers, or oligomers (e.g., the maleimides, bismaleimides, and polyimides) can be combined to form a binder. The binder can be solid, semi-solid, or liquid. Optionally, the binder has a decomposition temperature of less than 350° C.

Cyanate ester monomers contemplated for use herein contain two or more ring forming cyanate (—O—C≡N) groups which cyclotrimerize to form substituted triazine rings upon heating.

### Fillers

The compositions described herein also include one or more particulated, conductive fillers, wherein:
about 5 up to about 100 wt % of said particulated, conductive filler is particulated nickel or a particulated nickel-alloy, and
0 up to about 95 wt % of said particulated, conductive filler is particulated, conductive non-nickel-containing filler.

In some embodiments, the nickel or nickel-alloy filler contemplated for use herein comprises substantially 100 wt % nickel; in some embodiments, the nickel or nickel-alloy filler contemplated for use herein comprises at least about 20 wt % nickel; in some embodiments, the nickel or nickel-alloy filler comprises at least about 30 wt % nickel; in some embodiments, the nickel or nickel-alloy filler comprises in the range of about 30 up to about 50 wt % nickel; in some embodiments, the nickel or nickel-alloy filler comprises about 36 wt % nickel (wherein said nickel or nickel-alloy filler comprises about 64 wt % iron); in some embodiments, the nickel or nickel-alloy filler comprises at least about 40 wt % nickel; in some embodiments, the nickel or nickel-alloy filler comprises in the range of about 40 up to about 50 wt % nickel; in some embodiments, the nickel or nickel-alloy filler comprises in the range of about 41-43 wt % nickel; in some embodiments, the nickel or nickel-alloy filler comprises about 42 wt % nickel (wherein said nickel or nickel-alloy filler comprises about 58 wt % iron); in some embodiments, the nickel or nickel-alloy filler comprises at least about 50 wt % nickel; in some embodiments, the nickel or nickel-alloy filler comprises in the range of about 57-59 wt % nickel; in some embodiments, the nickel or nickel-alloy filler comprises in the range of about 30 up to about 80 wt % nickel.

In some embodiments, nickel or a nickel-alloy is present as the major conductive filler (i.e., at least 50 weight percent, at least 60 weight percent, at least 70 weight percent, at least 80 weight percent, or at least 90 weight percent) of the total conductive fillers present in the composition) along with one or more additional conductive fillers.

In some embodiments, the nickel or nickel-alloy filler comprises in the range of about 10 up to about 95 wt % of said particulated filler; in some embodiments, the nickel or nickel-alloy filler comprises in the range of about 20 up to about 85 wt % of said particulated filler; in some embodiments, the nickel or nickel-alloy filler comprises in the range of about 30 up to about 75 wt % of said particulated filler; in some embodiments, the nickel or nickel-alloy filler comprises in the range of about 40 up to about 60 wt % of said particulated filler.

In some embodiments, the nickel or nickel-alloy filler contemplated for use herein is substantially silver free.

In some embodiments, the nickel-alloy filler contemplated for use herein comprises nickel and iron, and, optionally, cobalt.

In some embodiments, the particulated, conductive non-nickel-containing filler contemplated for use herein is Ag, Cu, silver coated copper, silver coated glass, silver coated graphite, silver coated nickel, silver coated iron, silver coated nickel-iron alloy, silver coated ferrites, and the like, as well as mixtures of any two or more thereof.

In some embodiments, the ratio ofparticulated nickel-containing filler to particulated conductive non-nickel-containing filler falls in the range of about 10:1-1:10. In some embodiments, the ratio of particulated nickel-containing filler to particulated conductive non-nickel-containing filler falls in the range of about 8:1-1:8. In some embodiments, the ratio of particulated nickel-containing filler to particulated conductive non-nickel-containing filler falls in the range of about 6:1-1:6.

In some embodiments, the nickel or nickel-alloy filler contemplated for use herein has a particle size in the range of about 0.1 up to about 100 μm. In some embodiments, the nickel or nickel-alloy filler contemplated for use herein has a particle size in the range of about 1 up to about 50 μm. In some embodiments, the nickel or nickel-alloy filler contemplated for use herein has a particle size in the range of about 5 up to about 15 μm.

In some embodiments, the nickel or nickel-alloy filler contemplated for use herein is in the form of a powder or flake having a surface area in the range of about 0.01 up to about 10 m²/mg.

In some embodiments, the nickel or nickel-alloy filler contemplated for use herein has a tap density in the range of about 0.2 up to about 8 g/cm³.

In some embodiments, the filler surface is treated to increase filler/resin compatibility. Such treatments include mechanical treating to increase filler/resin compatibility, chemical treatment to increase filler/resin compatibility, and the like.

Exemplary mechanical treatments contemplated for use herein to increase filler/resin compatibility include plasma treatment, and the like.

Exemplary chemical treatments contemplated for use herein to increase filler/resin compatibility include treating the filler surface with a saturated fatty acid, an unsaturated fatty acid, a mixture of saturated and unsaturated fatty acid, a sorbitan ester, a fatty acid ester, an organosilane, and the like, or mixtures of any two or more thereof.

The conductive filler can have a size suitable for use in the methods described herein and is not limited to any particular range. Exemplary conductive fillers can have an average particle size ranging from about 0.1 μm to about 20 μm. In some embodiments, the conductive filler can have an average particle size ranging from about 1 μm to about 10 μm. In other embodiments, the conductive filler can have an average particle size that ranges from about 1 μm to about 3 μm.

The conductive filler is present in the composition in an amount of at least 65 percent by weight of the total solids content of the composition. For example, the conductive filler can be present in the composition in an amount of from about 65 percent by weight to about 95 percent by weight or from about 75 percent by weight to about 85 percent by weight. In some embodiments, the conductive filler can be present in the composition in an amount of at least about 65 percent by weight, at least about 70 percent by weight, at least about 75 percent by weight, at least about 80 percent by weight, at least about 85 percent by weight, or at least about 90 percent by weight of the total solids content of the composition.

The compositions described herein can optionally include one or more particulate fillers. The particulate filler can include, for example, silica, alumina, boron nitride, iron-based alloys, zirconium tungstate, or mixtures thereof. For example, the particulate filler can be a nickel/iron composition or a lithium aluminium silicate. Exemplary particulate fillers have a coefficient of thermal expansion (CTE) of 10 ppm/° C. or lower (e.g., 5 ppm/° C. or lower, 0 ppm/° C. or lower, or −5 ppm/° C. or lower). In some embodiments, the particulate fillers can include the following materials: carbon nanotubes, β-eucryptite, α-ZrW₂Os, β-ZrW₂O₈, Cd(CN)₂, ReO₃, (HfMg)(WO₄)₃, Sm_{2.75}C₆₀, Bi_{0.95}La_{0.05}NiO₃, Invar (Fe-36Ni), Invar (Fe₃Pt), Tm₂Fe₁₆Cr, CuO nanoparticles, Mn₃Cu_{0.53}Ge_{0.47}N, Mn₃ZN_{0.4}Sn_{0.6}N_{0.85}C_{0.15}, Mn₃Zn_{0.5}Sn_{0.5}N_{0.85}C_{0.1}B_{0.05}, and the like, as well as mixtures of any two or more thereof.

The particulate filler can be present in the composition in an amount of about 20 percent by weight or less (i.e., up to 20 percent by weight) of the total solids content of the composition. For example, the particulate filler can be present in the composition in an amount of less than about 20 percent by weight, less than about 19 percent by weight, less than about 18 percent by weight, less than about 17 percent by weight, less than about 16 percent by weight, less than about 15 percent by weight, less than about 14 percent by weight, less than about 13 percent by weight, less than about 12 percent by weight, less than about 11 percent by weight, less than about 10 percent by weight, less than about 9 percent by weight, less than about 8 percent by weight, less than about 7 percent by weight, less than about 6 percent by weight, less than about 5 percent by weight, less than about 4 percent by weight, less than about 3 percent by weight, less than about 2 percent by weight, or less than about 1 percent by weight of the total solids content of the composition.

### Curing Agents

The compositions described herein can optionally include one or more curing agents. The curing agents can optionally function as conductivity promoters and/or reducing agents in the compositions. Curing agents contemplated for use in the practice of the present invention include ureas, aliphatic and aromatic amines, polyamides, imidazoles, dicyandiamides, hydrazides, urea-amine hybrid curing systems, free radical initiators, organic bases, transition metal catalysts, phenols, acid anhydrides, Lewis acids, Lewis bases, and the like. See, for example, U.S. Pat. No. 5,397,618, the entire contents of which are hereby incorporated by reference herein.

The curing agent can optionally be present in the composition in an amount of up to about 4 percent by weight of the total solids content of the composition. In some embodiments, the curing agent is absent from the composition (i.e., 0 percent by weight of the total solids content of the composition). In other embodiments, the curing agent can be present in the composition in an amount from about 0.05 percent by weight to about 4 percent by weight or from about 0.1 percent by weight to about 3 percent by weight. Optionally, the curing agent is present in the composition in an amount of about 4 percent by weight or less, about 3 percent by weight or less, about 2 percent by weight or less, or about 1 percent by weight or less.

### Diluents

The compositions described herein can further include a diluent, including, for example, an organic diluent. The organic diluent can be a reactive organic diluent, a non-reactive organic.diluent, or a mixture thereof. Exemplary diluents include, for example, aromatic hydrocarbons (e.g., benzene, toluene, xylene, and the like); aliphatic hydrocarbons (e.g., hexane, cyclohexane, heptane, tetradecane, and the like); chlorinated hydrocarbons (e.g., methylene chloride, chloroform, carbon tetrachloride, dichloroethane, trichloroethylene, and the like); ethers (e.g., diethyl ether, tetrahydrofuran, dioxane, glycol ethers, monoalkyl or dialkyl ethers of ethylene glycol, and the like); esters (e.g., ethyl acetate, butyl acetate, methoxy propyl acetate, and the like); polyols (e.g., polyethylene glycol, propylene glycol, polypropylene glycol, and the like); ketones (e.g., acetone, methyl ethyl ketone, and the like); amides (e.g., dimethylformamide, dimethylacetamide, and the like); heteroaromatic compounds (e.g., N-methylpyrrolidone, and the like); and heteroaliphatic compounds.

The amount of non-reactive diluent contemplated for use in accordance with the present invention can vary widely, so long as a sufficient quantity is employed to dissolve and/or disperse the components of invention compositions. When present, the amount of non-reactive diluent employed typically falls in the range of about 2 up to about 30 percent by weight of the composition. In certain embodiments, the amount of non-reactive diluent falls in the range of about 5 up to 20 percent by weight of the total composition. In some embodiments, the amount of non-reactive diluent falls in the range of about 10 up to about 18 percent by weight of the total composition. The amount of reactive diluent contemplated for use in accordance with the present invention can be up to 5 percent by weight of the composition (e.g., 5 percent or less, 4 percent or less, 3 percent or less, 2 percent or less, or 1 percent or less).

As readily recognized by those of skill in the art, in certain embodiments, invention compositions contain substantially no non-reactive diluent therein. Even if non-reactive diluent is, at one time, present, it can be removed during the formation of films in the B-staging process, as further described herein.

Invention formulations may further comprise one or more flow additives, adhesion promoters, rheology modifiers, toughening agents, fluxing agents, film forming resins (up to 40 wt % when present), film flexibilizers, epoxy-curing catalysts, curing agents, and/or radical polymerization regulators, as well as mixtures of any two or more thereof.

As used herein, the term “flow additives” refers to compounds which modify the viscosity of the formulation to which they are introduced. Exemplary compounds which impart such properties include silicon polymers, ethyl acrylate/2-ethylhexyl acrylate copolymers, alkylol ammonium salts of phosphoric acid esters of ketoxime, and the like, as well as combinations of any two or more thereof.

As used herein, the term “adhesion promoters” refers to compounds which enhance the adhesive properties of the formulation to which they are introduced.

As used herein, the term “rheology modifiers” refers to additives which modify one or more physical properties of the formulation to which they are introduced.

As used herein, the term “toughening agents” refers to additives which enhance the impact resistance of the formulation to which they are introduced.

As used herein, the term “fluxing agents” refers to reducing agents which prevent oxides from forming on the surface of the molten metal.

As used herein, the term “film flexibilizers” refers to agents which impart flexibility to the films prepared from formulations containing same.

As used herein, the term “phenol-novolac hardeners” refers to materials which participate in the further interaction of reactive groups so as to increase the cross-linking thereof-thereby enhancing the stiffness thereof.

As used herein, the term “epoxy-curing catalysts” refers to reactive agents which promote oligomerization and/or polymerization of epoxy-containing moieties, e.g., imidazole.

As used herein, the term “curing agents” refers to reactive agents such as dicumyl peroxide which promote the curing of monomeric, oligomeric or polymeric materials.

In accordance with the present invention, provided herein are formulations useful as conductive inks. Exemplary conductive inks comprise:
in the range of about 5-50 wt % of a polymerizable monomer comprising a thermosetting or thermoplastic resin component selected from the group consisting of an acetal, an acrylic monomer, oligomer, or polymer, an acrylonitrile-butadiene-styrene (ABS) polymer or copolymer or a polycarbonate/ABS alloy, an alkyd, a butadiene, a styrene-butadiene, a cellulosic, a coumarone-indene, a cyanate ester, a diallyl phthalate (DAP), an epoxy monomer, oligomer, or polymer, a flexible epoxy or polymer with epoxy functional groups, a fluoropolymer, a melamine-formaldehyde, a neoprene, a nitrile resin, a novolac, a nylon, a petroleum resin, a phenolic, a polyamide-imide, a polyarylate and polyarylate ether sulfone or ketone, a polybutylene, a polycarbonate, a polyester and co-polyestercarbonate, a polyetherester, a polyethylene, a polyimide, a maleimide, a nadimide, an itaconamide, a polyketone, a polyolefin, a polyphenylene oxide, a sulfide, an ether, a polypropylene and polypropylene-EPDM blend, a polystyrene, a polyurea, a polyurethane, a vinyl polymer, rubbers, a silicone polymer, a siloxane polymer, a styrene acrylonitrile, a styrene butadiene latex and other styrene copolymers, a sulfone polymer, a thermoplastic polyester (Saturated), a phthalate, an unsaturated polyester, a urea-formaldehyde, a polyacrylamide, a polyglycol, a polyacrylic acid, a poly(ethylene glycol), an inherently conductive polymer, a fluoropolymers, as well as combinations of any two or more thereof,
in the range of about 45-95 wt/o of a particulated filler having a particle size in the range of 1 up to about 50 m, wherein:
   about 10 up to about 70 wt % of said particulated filler is a particulated nickel or particulated nickel-alloy, and
   0 up to about 65 wt % of said particulated filler is a particulated, conductive non-nickel-containing filler,
in the range of about 0.1-10 wt % of a curing agent selected from an amine, an acid, an anhydride, a dicyl, an imidazole, or a peroxide, and
a non-reactive organic diluent therefor, which, when present, is present in the amount of 20 up to 80 wt % of said formulation.

In some embodiments, conductive ink formulations contemplated herein comprise:
in the range of about 5-20 wt % of a polymerizable monomer comprising a thermosetting or thermoplastic resin component selected from the group consisting of a maleimide, a nadimide, an itaconamide, an acrylic monomer, oligomer, or polymer, an epoxy monomer, oligomer, or polymer, a flexible epoxy or polymer with epoxy functional groups, as well as combinations of any two or more thereof;
in the range of about 70-95 wt % of a particulated filler having a particle size in the range of 1 up to about 50 m, wherein:
   about 50 up to about 95 wt % of said particulated filler is a particulated nickel or particulated nickel-alloy, and
   5 up to about 50 wt % of said particulated filler is a particulated, conductive non-nickel-containing filler,
in the range of about 0.1-10 wt %/o of a curing agent selected from an amine, an acid, an anhydride, a dicyl, animidazole, or a peroxide, and
a non-reactive organic diluent therefor, which, when present, is present in the amount of 20 up to 80 wt % of said formulation.

In accordance with the present invention, also provided herein are formulations useful as conductive die attach films. Exemplary die attach film formulations comprise:
in the range of about 10-50 wt % of a polymerizable monomer comprising a thermosetting or thermoplastic resin component selected from the group consisting of an acetal, an acrylic monomer, oligomer, or polymer, an acrylonitrile-butadiene-styrene (ABS) polymer or copolymer or a polycarbonate/ABS alloy, an alkyd, a butadiene, a styrene-butadiene, a cellulosic, a coumarone-indene, a cyanate ester, a diallyl phthalate (DAP), an epoxy monomer, oligomer, or polymer, a flexible epoxy or polymer with epoxy functional groups, a fluoropolymer, a melamine-formaldehyde, a neoprene, a nitrile resin, a novolac, a nylon, a petroleum resin, a phenolic, a polyamide-imide, a polyarylate and polyarylate ether sulfone or ketone, a polybutylene, a polycarbonate, a polyester and co-polyestercarbonate, a polyetherester, a polyethylene, a polyimide, a maleimide, a nadimide, an itaconamide, a polyketone, a polyolefin, a polyphenylene oxide, a sulfide, an ether, a polypropylene and polypropylene-EPDM blend, a polystyrene, a polyurea, a polyurethane, a vinyl polymer, rubbers, a silicone polymer, a siloxane polymer, a styrene acrylonitrile, a styrene butadiene latex and other styrene copolymers, a sulfone polymer, a thermoplastic polyester (Saturated), a phthalate, an unsaturated polyester, a urea-formaldehyde, a polyacrylamide, a polyglycol, a polyacrylic acid, a poly(ethylene glycol), an inherently conductive polymer, a fluoropolymers, as well as combinations of any two or more thereof.
in the range of about 50-90 wt % of said filler having a particle size in the range of 1 up to about 50 m, wherein said filler comprises:
   about 1 up to about 90 wt % of a particulated nickel or nickel-alloy filler, and
   0 up to about 70 wt % of a particulated, conductive non-nickel-containing filler,
in the range of about 0-20 wt % of a film forming resin selected from a (meth)acrylate, an epoxy, a vinyl ether, a vinyl ester, a vinyl ketone, a vinyl aromatic, a vinyl cycloalkyl, or an allyl amide,
in the range of about 0.1-10 wt % of a curing agent selected from an amine, an acid, an anhydride, a dicyl, animidazole, or a peroxide, and
a non-reactive organic diluent therefor, which, when present, is present in the amount of 5 up to 50 wt % of said formulation.

In some embodiments, die attach film formulations contemplated herein comprise:
in the range of about 30-40 wt % of a polymerizable monomer comprising a thermosetting or thermoplastic resin component selected from the group consisting of a maleimide, a nadimide, an itaconamide, an epoxy monomer, oligomer, or polymer, a flexible epoxy or polymer with epoxy functional groups, as well as combinations of any two or more thereof.
in the range of about 50-90 wt % of said filler having a particle size in the range of 1 up to about 50 m, wherein said filler comprises:
   about 1 up to about 90 wt % of a particulated nickel or nickel-alloy filler, and
   0 up to about 70 wt % of a particulated, conductive non-nickel-containing filler,
in the range of about 0.1-10 wt % of a film forming resin selected from a (meth)acrylate, an epoxy, a vinyl ether, a vinyl ester, a vinyl ketone, a vinyl aromatic, a vinyl cycloalkyl, or an allyl amide,
in the range of about 0.1-10 wt % of a curing agent selected from an amine, an acid, an anhydride, a dicyl, animidazole, or a peroxide, and
a non-reactive organic diluent therefor, which, when present, is present in the amount of 5 up to 50 wt % of said formulation.

In accordance with the present invention, also provided herein are formulations useful as conductive die attach pastes. Exemplary die attach paste formulations comprise:
in the range of about 5-50 wt % of a polymerizable monomer comprising a thermosetting or thermoplastic resin component selected from the group consisting of an acetal, an acrylic monomer, oligomer, or polymer, an acrylonitrile-butadiene-styrene (ABS) polymer or copolymer or a polycarbonate/ABS alloy, an alkyd, a butadiene, a styrene-butadiene, a cellulosic, a coumarone-indene, a cyanate ester, a diallyl phthalate (DAP), an epoxy monomer, oligomer, or polymer, a flexible epoxy or polymer with epoxy functional groups, a fluoropolymer, a melamine-formaldehyde, a neoprene, a nitrile resin, a novolac, a nylon, a petroleum resin, a phenolic, a polyamide-imide, a polyarylate and polyarylate ether sulfone or ketone, a polybutylene, a polycarbonate, a polyester and co-polyestercarbonate, a polyetherester, a polyethylene, a polyimide, a maleimide, a nadimide, an itaconamide, a polyketone, a polyolefin, a polyphenylene oxide, a sulfide, an ether, a polypropylene and polypropylene-EPDM blend, a polystyrene, a polyurea, a polyurethane, a vinyl polymer, rubbers, a silicone polymer, a siloxane polymer, a styrene acrylonitrile, a styrene butadiene latex and other styrene copolymers, a sulfone polymer, a thermoplastic polyester (Saturated), a phthalate, an unsaturated polyester, a urea-formaldehyde, a polyacrylamide, a polyglycol, a polyacrylic acid, a poly(ethylene glycol), an inherently conductive polymer, a fluoropolymers, as well as combinations of any two or more thereof.
in the range of about 50-95 wt % of said filler, wherein said filler has a particle size in the range of 1 up to about 50 un, wherein said filler comprises:
   about 10 up to about 95 wt % of a particulated nickel or nickel-alloy filler, and
   0 up to about 85 wt % of a particulated, conductive non-nickel-containing filler,
in the range of about 0.1-20 wt % of a curing agent selected from an amine, an acid, an anhydride, a dicyl, an imidazole, or a peroxide, and
optionally, a reactive organic diluent therefor, which, when present, is present in the amount of 1 up to 30 wt % of said formulation, and is a low molecular weight epoxy diluent.

In some embodiments, die attach paste formulations contemplated herein comprise:
in the range of about 20-40 wt % of a polymerizable monomer comprising a thermosetting or thermoplastic resin component selected from the group consisting of a maleimide, a nadimide, an itaconamide, an epoxy monomer, oligomer, or polymer, a flexible epoxy or polymer with epoxy functional groups, as well as combinations of any two or more thereof.
in the range of about 50-95 wt % of said filler, wherein said filler has a particle size in the range of 1 up to about 50 μm, wherein said filler comprises:
   about 20 up to about 80 wt % of a particulated nickel or nickel-alloy filler, and
   20 up to about 80 wt % of a particulated, conductive non-nickel-containing filler,
in the range of about 0.1-20 wt % of a curing agent selected from an amine, an acid, an anhydride, a dicyl, an imidazole, or a peroxide, and
optionally, a reactive organic diluent therefor, which, when present, is present in the amount of 1 up to 30 wt % of said formulation, and is a low molecular weight epoxy diluent.

In accordance with the present invention, there are also provided methods for adhesively attaching a first article to a second article, said methods comprising:
(a) applying an aliquot of any of the formulations described herein to said first article,
(b) bringing said first and second articles into intimate contact to form an assembly wherein said first article and said second article are separated only by the formulation applied in step (a), and thereafter
(c) subjecting said assembly to conditions suitable to cure said formulation.

The compositions described herein provide a number of useful performance properties. For example, the composition, when cured, has a die shear strength of at least 1.0 kg/mm² at 260° C. (e.g., at least 1.5 kg/mm² at 260° C.). In addition, the composition undergoes lamination onto a wafer at a temperature of 100° C. or lower and a pressure of 40 psi or lower. Further, the composition, in the form of a film, can undergo dicing and pick-up processes to result in a die/film that can bond to a substrate at a temperature that can range from about 110° C. to 350° C. and under a pressure of from about 0.2 to 1 kg/mm². The die size can range from about 1×1 mm or less to about 8×8 mm or greater. The bonding time can be less than 3 seconds.

In certain embodiments of the present invention, there are provided methods of making the compositions described herein. The invention compositions can be made in the form of a film or in the form of a paste.

Invention methods for forming adhesive formulations comprise subjecting the contemplated combination of components to high shear mixing for a period of time sufficient to obtain a substantially homogeneous blend. In some embodiments, the components can be mixed for a period of time up to about 3 hours (e.g., from about 1 hour to 3 hours). The combination of components can be mixed at room temperature.

In embodiments where the composition is to be in the form of a film, the compositions are applied to a suitable substrate (e.g., a release liner), and then heated at elevated temperature to remove substantially all of the non-reactive diluent (i.e., solvent) therefrom. For example, at least 65%, at least 75%, at least 80%, at least 85%, at least 90%, at least 95%, or at least 99% of the solvent can be removed. The process of heating a paste or a film to dry it is referred to herein as B-staging. The resulting film can have a thickness of from about 5 microns to about 50 microns.

In certain embodiments of the present invention, there are provided films comprising the reaction product obtained upon removing substantially all of the solvent/diluent from the above-described B-staged compositions. The film can be wound on a roll.

The film as described herein can be laminated onto a substrate (e.g., a wafer) using a conventional laminator in the semi-conductor industry. For example, the film can be laminated onto a wafer using a roll laminator. Exemplary laminators that can be used include the DFM 2700 (Disco Corporation; Japan), the Leonardo 200 LD (Microcontrol Electronic; Italy), and the Western Magnum XRL-120 (El Segundo, Calif.). As described above, the lamination can be performed at a temperature of less than 100° C. (e.g., 95° C. or less, 90° C. or less, 85° C. or less, 80° C. or less, 75° C. or less, 70° C. or less, or 65° C. or less). The lamination can be performed at a pressure of 40 psi or less (e.g., 35 psi or less or 30 psi or less).

The release liner, if used, can be peeled off from the film. The film can then be laminated to a dicing tape, which serves as support during the dicing process. The lamination of the film to the dicing tape can be performed at room temperature. As a result of the lamination process, the film is held between and in direct contact with the dicing tape and the wafer. During the dicing process, the wafer and film can be diced into individual dies with the film adhered to the die. The individual dies and adhered film can be removed from the dicing tape during the pick-up process and then can be attached to a substrate in a bonding/die attach step. The bonding/die attach step can be performed at a temperature of from about 110° C. to 350° C. for a bonding time of less than 3 seconds. A bonding/die attach pressure of 0.2 kg/mm² to 1 kg/mm² can be used for a variety of die sizes (e.g., for die sizes ranging from less than 1×1 mm to 8×8 mm or above). The resulting die/film/substrate assembly can then be processed in at least one thermal operation, such as curing in an oven, wirebonding followed by molding, and the like.

Suitable substrates contemplated for use herein include lead-frame(s). As used herein, “lead-frame(s)” comprise a base plate consisting of copper or copper alloys, and a protective coating formed on the upper (or both) surface(s) of the base plate. The protective coating is composed of at least one metal selected from the group consisting of gold, gold alloy, silver, silver alloy, palladium or palladium alloy, and has a thickness of about 10-500 angstrom. The protective coating is formed by suitable means, e.g., by vapor deposition. It is possible to form an intermediate coating of nickel or nickel alloys between the surface of the base plate and the protective coating, by means of vapor deposition or wet plating. A suitable thickness for the intermediate coating is within the range of about 50-20,000 angstrom. See, for example, U.S. Pat. No. 5,510,197, the entire contents of which are hereby incorporated by reference herein.

Optionally, the substrates for use in the present invention include laminate substrate(s) designed for semiconductor packages (e.g., BT substrate, FR4 substrate, and the like), polyethylene terephthalate, polymethyl methacrylate, polyethylene, polypropylene, polycarbonate, an epoxy resin, polyimide, polyamide, polyester, glass, and the like.

In accordance with yet another embodiment of the present invention, there are provided methods for preparing die attach films and pastes. For pastes, the methods can comprise curing the above-described compositions after application thereof to a suitable substrate, as described above. For films, the methods can comprise high temperature bonding of the dies and films to a suitable substrate, as described above. Optionally, the methods for preparing die attach films can include a curing process to optimize the morphology and for device stress stabilization. The curing process can be performed in an oven.

As described herein, the films and pastes according to the present invention can be used for die attach. The die surface can optionally be coated with a metal, such as silver.

In accordance with yet another embodiment of the present invention, there are provided articles comprising die attach films and pastes as described herein adhered to a suitable substrate therefor.

Articles according to the present invention can be characterized in terms of the adhesion of the cured die attach film or paste to the substrate; typically the adhesion is at least about 1.0 kg/mm² at 260° C. (e.g., at least about 1.5 kg/mm² at 260° C.); in some embodiments, the adhesion is at least about 2.5 kg/mm² at 260° C. As described above, the die shear strength is measured on a die shear tester using a die metallized with titanium-nickel-silver and a silver-coated lead-frame substrate.

As readily recognized by those of skill in the art, the dimensions of invention articles can vary over a wide range. Exemplary articles include, for example, semiconductor dies. Dies for use in the present invention can vary in surface area. In some embodiments, semiconductor dies for use in the present invention can range from 1×1 mm or less to 8×8 mm or greater.

In accordance with yet another embodiment of the present invention, there are provided methods for laminating a film onto a semiconductor wafer, comprising:

applying a composition for a film as described herein to a semiconductor wafer; and

laminating the composition onto the semiconductor wafer at a temperature of 100° C. or lower and a pressure of 40 psi or lower.

In accordance with yet another embodiment of the present invention, there are provided methods for preparing a conductive network, said method comprising:

applying a composition for a film as described herein to a wafer;

laminating the composition onto the wafer at a temperature of 100° C. or lower and a pressure of 40 psi or lower to result in a film attached to a wafer;

dicing the film attached to the wafer to result in a die and film; and

bonding the die and film to a substrate under a pressure of 0.2 kg/mm² to 1 kg/mm².

In accordance with yet another embodiment of the present invention, there are provided methods for preparing a conductive network, said method comprising:

applying a composition for a paste as described herein to a substrate (e.g., a lead-frame) in a predefined pattern;

die attaching the composition to a die and the substrate; and

curing the composition.

Optionally, the composition can be applied such that the resulting film or paste is present at a thickness of at least about 5 microns. For example, the thickness of the film can be from about 5 microns to about 50 microns (e.g., from about 5 microns to about 30 microns) and the thickness of the paste can be from about 5 microns to about 50 microns.

In accordance with still another embodiment of the present invention, there are provided conductive networks prepared as described herein.

The formulations described herein can be used within the electronics industry and other industrial applications. For example, the formulations described herein can be used for die attach applications on lead-frames for power discretes, for clip attach applications as wire bond replacements for high performance discretes, for heat slug attach applications for the cooling of power discretes with exposed pads, for single- and multi-die devices, and for other devices requiring high electrical and/or thermal conductivity between a die and a frame.

Various aspects of the present invention are illustrated by the following non-limiting examples. The examples are for illustrative purposes and are not a limitation on any practice of the present invention. It will be understood that variations and modifications can be made without departing from the spirit and scope of the invention. One of ordinary skill in the art readily knows how to synthesize or commercially obtain the reagents and components described herein.

### Example 1

### Adhesive Films

Formulations according to the invention were prepared by combining the components set forth in Table 1, as follows.

TABLE 1

| | | | Example 1 |
|---|---|---|---|
| Ingredient | Supplier Name | Product Name | (Film) |
| Phenylmethane | Daiwakasei | Daiwakasei BMI 2300 | 8 |
| maleimide | | | |
| Bis A Epoxy | Japan Epoxy | jER YL 980 | 3 |
| Carboxy- | Henkel | 24-440B | 6.3 |
| terminated | | | |
| butadiene | | | |
| acrylnitrile | | | |
| copolymer | | | |
| Acrylic Ester | Nagase Chem Corp | Taisen Resin SG-P3 | 3 |
| Copolymer | | | |
| Dicyandiamide | Dow Chemical | D.E.R. 354 | 0.4 |
| silane | Dowcorning | Z-6040 | 0.1 |
| Adipic Acid | | | 0.1 |
| silver | Ferro | SF98 | 20 |
| FeNi Alloy | | Alloy 42 | 60 |
| MEK | | | 15 |
| VR (Ohm cm) | | | 0.01 |

The volume resistivity (VR) of the resulting formulation was evaluated as noted in Table 1, demonstrating that an exemplary formulation according to the invention (wherein 75% of the particulated, conductive filler is nickel or a nickel-alloy, and only 25% of the particulated, conductive filler is silver), provides an adhesive film with a desirable VR of 1×10⁻² Ohm cm.

### Example 2

### Adhesive Films

Additional formulations according to the invention were prepared by combining the components set forth in Table 2, as follows.

TABLE 2

| | | | Example 2 |
|---|---|---|---|
| Ingredient | Supplier Name | Product Name | (Film) |
| Phenylmethane | Daiwakasei | Daiwakasei BMI 2300 | 2 |
| maleimide | | | |
| Bis A Epoxy | Japan Epoxy | jER YL 980 | 3 |
| Novalec Epoxy | DIC | Epiclon N-730A | 4 |
| Epoxidized | Nagase | Epolead PB3600 | 10 |
| butadiene | | | |
| Dicyandiamide | Dow Chemical | D.E.R. 354 | 0.5 |
| silane | Dowcorning | Z-6040 | 0.1 |
| Adipic Acid | | | 0.1 |
| silver | Ferro | SF98 | 25 |
| FeNi Alloy | | Alloy 42 | 55 |
| solvent | | | 3 |
| VR (Ohm cm) | | | 0.002 |

The volume resistivity (VR) of the resulting formulation was evaluated as noted in Table 2, demonstrating that an exemplary formulation according to the invention (wherein about 69% of the particulated, conductive filler is nickel or a nickel-alloy, and only 31% of the particulated, conductive filler is silver), provides an adhesive film with a desirable VR of 2×10⁻³ Ohm cm.

### Example 3

### Adhesive Pastes

Additional formulations according to the invention were prepared by combining the components set forth in Table 3, as follows.

TABLE 3

| | | | Example 3 |
|---|---|---|---|
| Ingredient | Supplier Name | Product Name | (Paste) |
| Novalec Epoxy | DIC | Epiclon N-730 | 15 |
| 1,4-Butanediol- | Hunstman | Araldite DY026 | 10 |
| diglycidylether | | | |
| Diaminodiphenyl sulfone | Sumitomo | Seikacure S | 0.5 |
| silane | Dowcorning | Z-6040 | 0.1 |
| Adipic Acid | | | 0.1 |
| silver | Ferro | KP84 | 15 |
| silver | Ferro | SF98 | 5 |
| FeNi Alloy | | Alloy 42 | 60 |
| VR (Ohm cm) | | | 0.002 |

The volume resistivity (VR) of the resulting formulation was evaluated as noted in Table 3, demonstrating that an exemplary formulation according to the invention (wherein 75% of the particulated, conductive filler is nickel or a nickel-alloy, and only 25% of the particulated, conductive filler is silver), provides an adhesive paste with a desirable VR of 2×10⁻³ Ohm cm.

### Example 4

### Adhesive Pastes

Additional formulations according to the invention were prepared by combining the components set forth in Table 4, as follows.

TABLE 4

| | | | Example 4 |
|---|---|---|---|
| Ingredient | Supplier Name | Product Name | (Paste) |
| Bis F epoxy | DIC | Epiclon N-830 | 9.8 |
| 1,4-Butanediol- | Hunstman | Araldite DY026 | 8 |
| diglycidylether | | | |
| Phenolic resin | Schenectady | SP1045 | 4 |
| | International | | |
| Silane | Dowcorning | Z-6040 | 0.1 |
| Adipic Acid | | | 0.1 |
| Silver | Ferro | EA0097 | 10 |
| Silver | Metalor | EA0101 | 10 |
| FeNi Alloy | | Alloy 42 | 55 |
| V.R. | | | 0.0008 |

The volume resistivity (VR) of the resulting formulation was evaluated as noted in Table 4, demonstrating that an exemplary formulation according to the invention (wherein about 73% of the particulated, conductive filler is nickel or a nickel-alloy, and only about 26% of the particulated, conductive filler is silver), provides an adhesive paste with a desirable VR of 8×10⁻⁴ Ohm cm.

### Example 5

### Adhesive Pastes

Additional formulations according to the invention were prepared by combining the components set forth in Table 5, as follows.

TABLE 5

| | | | Example 5 |
|---|---|---|---|
| Ingredient | Supplier Name | Product Name | (Paste) |
| Tricyclodecane dimethanol | Sartomer | SR833S | 4.5 |
| diacrylate | | | |
| Ethoxylated Bisphenol A | Sartomer | SR349 | 7.5 |
| diacrylate | | | |
| Maelinized butadiene | Sartomer | Ricon130 MA | 8 |
| t-butyl peroxybenzonate | Akzo Nobel | Trigonox C | 0.9 |
| Adipic Acid | | | 0.1 |
| silver | Technic | Silflake 94-126 | 14 |
| silver | Metalor | EA0101 | 10 |
| FeNi Alloy | | Alloy 42 | 55 |
| VR (Ohm cm) | | | 0.002 |

The volume resistivity (VR) of the resulting formulation was evaluated as noted in Table 5, demonstrating that an exemplary formulation according to the invention (wherein 65% of the particulated, conductive filler is nickel or a nickel-alloy, and only 35% of the particulated, conductive filler is silver), provides an adhesive film with a desirable VR of2×10⁻³ Ohm cm.

### Example 6

### Conductive Inks

Formulations according to the invention were prepared by combining the components set forth in Table 6, as follows.

TABLE 6

| | | | Example 6 |
|---|---|---|---|
| Ingredient | Supplier Name | Product Name | (ink) |
| Phenoxy resin | InchemRez | PKHC | 5 |
| Carbitol Acetate | Sigma Aldrich | | 15 |
| Silver | Ferro | 94-126 | 10 |
| FeNi Alloy | | Alloy 42 | 85 |
| VR (Ohm cm) | | | 0.004 |

The volume resistivity (VR) of the resulting formulation was evaluated as noted in Table 6, demonstrating that an exemplary formulation according to the invention (wherein about 89% of the particulated, conductive filler is nickel or a nickel-alloy, and only 10% of the particulated, conductive filler is silver), provides a conductive ink with a desirable VR of 4×10⁻³ Ohm cm.

### Example 7

### Conductive Inks

Formulations according to the invention were prepared by combining the components set forth in Table 7, as follows.

TABLE 7

| | | | Example 7 |
|---|---|---|---|
| Ingredient | Supplier Name | Product Name | (ink) |
| Styrene-butadiene | Kraton | G1657 | 5 |
| copolymer | | | |
| toluene | Sigma Aldrich | | 15 |
| Silver | Ferro | 94-126 | 20 |
| FeNi Alloy | | Alloy 42 | 75 |
| VR (Ohm cm) | | | 0.0005 |

The volume resistivity (VR) of the resulting formulation was evaluated as noted in Table 7, demonstrating that an exemplary formulation according to the invention (wherein about 79% of the particulated, conductive filler is nickel or a nickel-alloy, and only about 21% of the particulated, conductive filler is silver), provides a conductive ink with a desirable VR of 5×10⁻⁴ Ohm cm.

### Example 8

### Conductive Inks

Formulations according to the invention were prepared by combining the components set forth in Table 8, as follows.

TABLE 8

| | | | Example 8 |
|---|---|---|---|
| Ingredient | Supplier Name | Product Name | (ink) |
| glycidal methacrylate | NOF | Marproof G2050 | 11 |
| copolymer with styrene | | | |
| Carbitol Acetate | Sigma Aldrich | | 35 |
| Imidazol | Airproduct | EMI-24-CN | 0.5 |
| Silver | Ferro | KP84 | 20 |
| FeNi Alloy | | Alloy 42 | 60 |
| propylene glycol methyl | Dow | Dowanol PMA | 24 |
| ether acetate | | | |
| VR (Ohm cm) | | | 0.006 |

The volume resistivity (VR) of the resulting formulation was evaluated as noted in Table 8, demonstrating that an exemplary formulation according to the invention (wherein 75% of the particulated, conductive filler is nickel or a nickel-alloy, and only 25% of the particulated, conductive filler is silver), provides an adhesive film with a desirable VR of 6×10⁻³ Ohm cm.

### Example 9

### Conductive Inks

Formulations according to the invention were prepared by combining the components set forth in Table 9, as follows.

TABLE 9

| | | | Example 9 |
|---|---|---|---|
| Ingredient | Supplier Name | Product Name | (ink) |
| Phenoxy resin | InchemRez | PKHC | 9.68 |
| Carbitol Acetate | Sigma Aldrich | | 22.6 |
| Silver | Ferro | 94-126 | 19.36 |
| FeNi Alloy | | Alloy 42 | 19.36 |
| Butyle Acetate | Sigma Aldrich | | 29 |
| VR (Ohm cm) | | | 0.0009 |

The volume resistivity (VR) of the resulting formulation was evaluated as noted in Table 9, demonstrating that an exemplary formulation according to the invention (wherein 50% of the particulated, conductive filler is nickel or a nickel-alloy, and 50% of the particulated, conductive filler is silver), provides a conductive ink with a desirable VR of 9×10⁻⁴ Ohm cm.

Various modifications of the present invention, in addition to those shown and described herein, will be apparent to those skilled in the art of the above description. Such modifications are also intended to fall within the scope of the appended claims.

Patents and publications mentioned in the specification are indicative of the levels of those skilled in the art to which the invention pertains. These patents and publications are incorporated herein by reference to the same extent as if each individual application or publication was specifically and individually incorporated herein by reference.

The foregoing description is illustrative of particular embodiments of the invention, but is not meant to be a limitation upon the practice thereof. The following claims, including all equivalents thereof, are intended to define the scope of the invention.

That which is claimed is:

1. An electrically conductive adhesive formulation, said formulation comprising:
about 5 up to about 50 wt % of an organic matrix,
about 45 up to about 95 wt % of a particulated filler, wherein:
about 5 up to about 100 wt % of said particulated filler is particulated nickel or a particulated nickel-alloy, and
0 up to about 95 wt % of said particulated filler is particulated, conductive non-nickel-containing filler,
optionally a curing agent, which, when present, is present in the range of about 0.1 up to about 20 wt %, and
optionally a reactive and/or non-reactive organic diluent therefor,
wherein said formulation, upon curing thereof, has a volume resistivity in the range of about 10⁻⁵ up to about 10 Ohm cm.

2. The formulation of claim 1 wherein the formulation is further characterized by one or more of the following:
the volume resistivity of said formulation falls in the range of about 10⁻⁴ up to about 10 Ohm cm,
said formulation is such that the effect of corrosion on the electrical properties of the particulated filler is minimal, and
the coefficient of thermal expansion (CTE) of said formulation is highly compatible with silicon wafers to which it may be applied.

3. The formulation of claim 1 wherein said organic matrix comprises one or more polymerizable monomer.

4. The formulation of claim 3 wherein said polymerizable monomer is a thermosetting or thermoplastic resin component selected from the group consisting of an acetal, an acrylic monomer, oligomer, or polymer, an acrylonitrile-butadiene-styrene (ABS) polymer or copolymer or a polycarbonate/ABS alloy, an alkyd, a butadiene, a styrene-butadiene, a cellulosic, a coumarone-indene, a cyanate ester, a diallyl phthalate (DAP), an epoxy monomer, oligomer, or polymer, a flexible epoxy or polymer with epoxy functional groups, a fluoropolymer, a melamine-formaldehyde, a neoprene, a nitrile resin, a novolac, a nylon, a petroleum resin, a phenolic, a polyamide-imide, a polyarylate and polyarylate ether sulfone or ketone, a polybutylene, a polycarbonate, a polyester and co-polyestercarbonate, a polyetherester, a polyethylene, a polyimide, a polyketone, a polyolefin, a polyphenylene oxide, a sulfide, an ether, a polypropylene and polypropylene-EPDM blend, a polystyrene, a polyurea, a polyurethane, a vinyl polymer, rubbers, a silicone polymer, a siloxane polymer, a styrene acrylonitrile, a styrene butadiene latex and other styrene copolymers, a sulfone polymer, a thermoplastic polyester (Saturated), a phthalate, an unsaturated polyester, a urea-formaldehyde, a polyacrylamide, a polyglycol, a polyacrylic acid, a poly(ethylene glycol), an inherently conductive polymer, a fluoropolymers, as well as combinations of any two or more thereof.

5. The formulation of claim 4 wherein said maleimide, nadimide, or itaconamide has the structure: 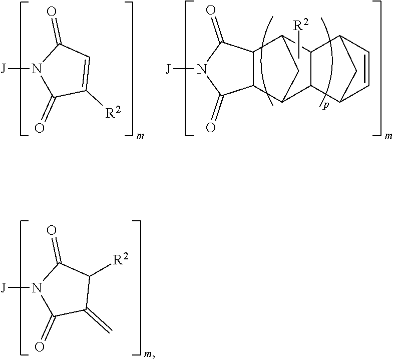
respectively, wherein:
m is 1-15,
p is 0-15,
each R² is independently selected from hydrogen or lower alkyl (such as C₁₋₅), and
J is a monovalent or a polyvalent radical comprising organic or organosiloxane radicals, and
combinations of any two or more thereof.

6. The formulation of claim 5, wherein J is a monovalent or polyvalent radical selected from:
hydrocarbyl or substituted hydrocarbyl species typically having in the range of about 6 up to about 500 carbon atoms, where the hydrocarbyl species is selected from alkyl, alkenyl, alkynyl, cycloalkyl, cycloalkenyl, aryl, alkylaryl, arylalkyl, aryalkenyl, alkenylaryl, arylalkynyl or alkynylaryl, provided, however, that X can be aryl only when X comprises a combination of two or more different species;
hydrocarbylene or substituted hydrocarbylene species typically having in the range of about 6 up to about 500 carbon atoms, where the hydrocarbylene species are selected from alkylene, alkenylene, alkynylene, cycloalkylene, cycloalkenylene, arylene, alkylarylene, arylalkylene, arylalkenylene, alkenylarylene, arylalkynylene or alkynylarylene,
heterocyclic or substituted heterocyclic species typically having in the range of about 6 up to about 500 carbon atoms,
polysiloxane, or
polysiloxane-polyurethane block copolymers, as well as
combinations of one or more of the above with a linker selected from covalent bond, —O—, —S—, —NR—, —NR—C(O)—, —NR—C(O)—O—, —NR—C(O)—NR—, —S—C(O)—, —S—C(O)—O—, —S—C(O)—NR—, —O—S(O)₂—, —O—S(O)₂—O—, —O—S(O)₂—NR—, —O—S(O)—, —O—S(O)—O—, —O—S(O)—NR—, —O—NR—C(O)—, —O—NR—C(O)—O—, —O—NR—C(O)—NR—, —NR—O—C(O)—, —NR—O—C(O)—O—, —NR—O—C(O)—NR—, —O—NR—C(S)—, —O—NR—C(S)—O—, —O—NR—C(S)—NR—, —NR—O—C(S)—, —NR—O—C(S)—O—, —NR—O—C(S)—NR—, —O—C(S)—, —O—C(S)—O—, —O—C(S)—NR—, —NR—C(S)—, —NR—C(S)—O—, —NR—C(S)—NR—, —S—S(O)₂—, —S—S(O)₂—O—, —S—S(O)₂—NR—, —NR—O—S(O)—, —NR—O—S(O)—O—, —NR—O—S(O)—NR—, —NR—O—S(O)—, —NR—O—S(O)₂—O—, —NR—O—S(O)₂—NR—, —O—NR—S(O)—, —O—NR—S(O)—O—, —O—NR—S(O)—NR—, —O—NR—S(O)₂—O—, —O—NR—S(O)₂—NR—, —O—NR—S(O)₂—, —O—P(O)R₂—, —S—P(O)R₂—, or —NR—P(O)R₂—; where each R is independently hydrogen, alkyl or substituted alkyl.

7. The formulation of claim 4 wherein said maleimide, nadimide, or itaconamide is selected from the group consisting of 4,4′-diphenylmethane bismaleimide, 4,4′-diiphenylether bismaleimide, 4,4′diiphenylsulfone bismaleimide, phenylmethane maleimide, m-phenylene bismaleimide, 2,2′-bis[4-(4-maleimidophenoxy)phenyl]propane, 3,3′-dimethyl-5,5′-diethyl-4,4′-diphenylmethane bismaleimide, 4-methyl-1,3-phenylene bismaleimide, 1,6′-bismaleimide-(2,2,4-trimethyl)hexane, 1,3-bis(3-maleimidophenoxy)benzene, and 1,3-bis(4-maleimidophenoxy)-benzene.

8. The formulation of claim 4 wherein said (meth)acrylate is selected from the group consisting of monofunctional (meth)acrylates, difunctional (meth)acrylates, trifunctional (meth)acrylates, polyfunctional (meth)acrylates, and mixtures of any two or more thereof.

9. The formulation of claim 4 wherein said epoxy is selected from the group consisting of liquid-type epoxy resins based on bisphenol A, solid-type epoxy resins based on bisphenol A, liquid-type epoxy resins based on bisphenol F, multifunctional epoxy resins based on phenol-novolac resin, dicyclopentadiene-type epoxy resins, naphthalene-type epoxy resins, as well as mixtures of any two or more thereof.

10. The formulation of claim 4 wherein said cyanate ester monomers contemplated for use herein contain two or more ring forming cyanate (—O—C≡N) groups which cyclotrimerize to form substituted triazine rings upon heating.

11. The formulation of claim 4 wherein said organic matrix further comprises one or more flow additives, adhesion promoters, theology modifiers, toughening agents, fluxing agents, film forming resins, film flexibilizers, epoxy-curing catalysts, curing agents, and/or radical polymerization regulators, as well as mixtures of any two or more thereof.

12. The formulation of claim 1 wherein said nickel or nickel-alloy filler comprises substantially 100 wt % nickel.

13. The formulation of claim 1 wherein said nickel or nickel-alloy filler is substantially silver free.

14. The formulation of claim 1 wherein said nickel-alloy filler comprises nickel and iron, and, optionally, cobalt.

15. The formulation of claim 1 wherein said particulated conductive non-nickel-containing filler is selected from the group consisting of Ag, Cu, silver coated copper, silver coated glass, silver coated graphite, silver coated nickel, silver coated iron, silver coated nickel-iron alloy, silver coated ferrites, and mixtures of any two or more thereof.

16. The formulation of claim 1 wherein the ratio of particulated nickel-containing filler to particulated conductive non-nickel-containing filler falls in the range of about 10:1-1:10.

17. The formulation of claim 1 wherein said nickel or nickel-alloy filler has a particle size in the range of about 0.1 up to about 100 μm.

18. The formulation of claim 1 wherein said nickel or nickel-alloy filler is in the form of a powder or flake having a surface area in the range of about 0.01 up to about 10 m²/mg.

19. The formulation of claim 1 wherein said nickel or nickel-alloy filler has a tap density in the range of about 0.2 up to about 8 g/cm³.

20. The formulation of claim 1, wherein the filler surface is treated to increase filler/resin compatibility.

21. The formulation of claim 20, wherein the filler surface is mechanically treated to increase filler/resin compatibility.

22. The formulation of claim 20, wherein the filler surface is chemically treated to increase filler/resin compatibility.

23. The formulation of claim 22 wherein a saturated fatty acid, an unsaturated fatty acid, a mixture of saturated and unsaturated fatty acid, a sorbitan ester, a fatty acid ester, an organosilane, or mixtures of any two or more thereof are used for the filler surface treatment.

24. The formulation of claim 1 wherein said nickel or nickel-alloy filler comprises in the range of about 10 up to about 95 wt % of said particulated filler.

25. The formulation of claim 1 wherein the formulation is a conductive ink.

26. The formulation of claim 25 wherein said conductive ink comprises:
in the range of about 5-50 wt % of a polymerizable monomer comprising a thermosetting or thermoplastic resin component selected from the group consisting of an acetal, an acrylic monomer, oligomer, or polymer, an acrylonitrile-butadiene-styrene (ABS) polymer or copolymer or a polycarbonate/ABS alloy, an alkyd, a butadiene, a styrene-butadiene, a cellulosic, a coumarone-indene, a cyanate ester, a diallyl phthalate (DAP), an epoxy monomer, oligomer, or polymer, a flexible epoxy or polymer with epoxy functional groups, a fluoropolymer, a melamine-formaldehyde, a neoprene, a nitrile resin, a novolac, a nylon, a petroleum resin, a phenolic, a polyamide-imide, a polyarylate and polyarylate ether sulfone or ketone, a polybutylene, a polycarbonate, a polyester and co-polyestercarbonate, a polyetherester, a polyethylene, a polyimide, a polyketone, a polyolefin, a polyphenylene oxide, a sulfide, an ether, a polypropylene and polypropylene-EPDM blend, a polystyrene, a polyurea, a polyurethane, a vinyl polymer, rubbers, a silicone polymer, a siloxane polymer, a styrene acrylonitrile, a styrene butadiene latex and other styrene copolymers, a sulfone polymer, a thermoplastic polyester (Saturated), a phthalate, an unsaturated polyester, a urea-formaldehyde, a polyacrylamide, a polyglycol, a polyacrylic acid, a poly(ethylene glycol), an inherently conductive polymer, a fluoropolymers, as well as combinations of any two or more thereof,
in the range of about 45-95 wt % of a particulated filler having a particle size in the range of 1 up to about 50 μm, wherein:
about 10 up to about 70 wt % of said particulated filler is a particulated nickel or particulated nickel-alloy, and
0 up to about 65 wt % of said particulated filler is a particulated, conductive non-nickel-containing filler,
in the range of about 0.1-10 wt % of a curing agent selected from an amine, an acid, an anhydride, a dicyl, animidazole, or a peroxide, and
a non-reactive organic diluent therefor, which, when present, is present in the amount of 20 up to 80 wt % of said formulation.

27. The formulation of claim 1 wherein the formulation is a conductive die attach film.

28. The formulation of claim 27 wherein said die attach film comprises:
in the range of about 10-50 wt % of a polymerizable monomer comprising a thermosetting or thermoplastic resin component selected from the group consisting of an acetal, an acrylic monomer, oligomer, or polymer, an acrylonitrile-butadiene-styrene (ABS) polymer or copolymer or a polycarbonate/ABS alloy, an alkyd, a butadiene, a styrene-butadiene, a cellulosic, a coumarone-indene, a cyanate ester, a diallyl phthalate (DAP), an epoxy monomer, oligomer, or polymer, a flexible epoxy or polymer with epoxy functional groups, a fluoropolymer, a melamine-formaldehyde, a neoprene, a nitrile resin, a novolac, a nylon, a petroleum resin, a phenolic, a polyamide-imide, a polyarylate and polyarylate ether sulfone or ketone, a polybutylene, a polycarbonate, a polyester and co-polyestercarbonate, a polyetherester, a polyethylene, a polyimide, a polyketone, a polyolefin, a polyphenylene oxide, a sulfide, an ether, a polypropylene and polypropylene-EPDM blend, a polystyrene, a polyurea, a polyurethane, a vinyl polymer, rubbers, a silicone polymer, a siloxane polymer, a styrene acrylonitrile, a styrene butadiene latex and other styrene copolymers, a sulfone polymer, a thermoplastic polyester (Saturated), a phthalate, an unsaturated polyester, a urea-formaldehyde, a polyacrylamide, a polyglycol, a polyacrylic acid, a poly(ethylene glycol), an inherently conductive polymer, a fluoropolymers, as well as combinations of any two or more thereof.
in the range of about 50-90 wt % of said filler having a particle size in the range of 1 up to about 50 μm, wherein said filler comprises:
about 1 up to about 90 wt % of a particulated nickel or nickel-alloy filler, and
0 up to about 70 wt % of a particulated, conductive non-nickel-containing filler,
in the range of about 0-20 wt % of a film forming resin selected from a (meth)acrylate, an epoxy, a vinyl ether, a vinyl ester, a vinyl ketone, a vinyl aromatic, a vinyl cycloalkyl, or an allyl amide,
in the range of about 0.1-10 wt % of a curing agent selected from an amine, an acid, an anhydride, a dicyl, animidazole, or a peroxide, and
a non-reactive organic diluent therefor, which, when present, is present in the amount of 5 up to 50 wt % of said formulation.

29. The formulation of claim 1 wherein the formulation is a die attach paste.

30. The formulation of claim 29 wherein said die attach paste comprises:
in the range of about 5-50 wt % of a polymerizable monomer comprising a thermosetting or thermoplastic resin component selected from the group consisting of an acetal, an acrylic monomer, oligomer, or polymer, an acrylonitrile-butadiene-styrene (ABS) polymer or copolymer or a polycarbonate/ABS alloy, an alkyd, a butadiene, a styrene-butadiene, a cellulosic, a coumarone-indene, a cyanate ester, a diallyl phthalate (DAP), an epoxy monomer, oligomer, or polymer, a flexible epoxy or polymer with epoxy functional groups, a fluoropolymer, a melamine-formaldehyde, a neoprene, a nitrile resin, a novolac, a nylon, a petroleum resin, a phenolic, a polyamide-imide, a polyarylate and polyarylate ether sulfone or ketone, a polybutylene, a polycarbonate, a polyester and co-polyestercarbonate, a polyetherester, a polyethylene, a polyimide, a polyketone, a polyolefin, a polyphenylene oxide, a sulfide, an ether, a polypropylene and polypropylene-EPDM blend, a polystyrene, a polyurea, a polyurethane, a vinyl polymer, rubbers, a silicone polymer, a siloxane polymer, a styrene acrylonitrile, a styrene butadiene latex and other styrene copolymers, a sulfone polymer, a thermoplastic polyester (Saturated), a phthalate, an unsaturated polyester, a urea-formaldehyde, a polyacrylamide, a polyglycol, a polyacrylic acid, a poly(ethylene glycol), an inherently conductive polymer, a fluoropolymers, as well as combinations of any two or more thereof.
in the range of about 50-95 wt % of said filler, wherein said filler has a particle size in the range of 1 up to about 50 μm, wherein said filler comprises:
about 10 up to about 95 wt % of a particulated nickel or nickel-alloy filler, and
0 up to about 85 wt % of a particulated, conductive non-nickel-containing filler,
in the range of about 0.1-20 wt % of a curing agent selected from an amine, an acid, an anhydride, a dicyl, an imidazole, or a peroxide, and
optionally, a reactive organic diluent therefor, which, when present, is present in the amount of 1 up to 30 wt % of said formulation, and is a low molecular weight epoxy diluents.

31. An assembly comprising a first article permanently adhered to a second article by a cured aliquot of a formulation according to claim 1.

32. A method for adhesively attaching a first article to a second article, said method comprising:
(a) applying an aliquot of the formulation of claim 1 to said first article,
(b) bringing said first and second articles into intimate contact to form an assembly wherein said first article and said second article are separated only by the formulation applied in step (a), and thereafter
(c) subjecting said assembly to conditions suitable to cure said formulation.
